(19) United States
(12) Patent Application Publication
(10) Pub. No.: US 2026/0082474 A1
(43) Pub. Date: Mar. 19, 2026

(54) ELECTRONIC CIRCUIT AND METHOD FOR HEATING A FILAMENT OF AN X-RAY TUBE

(71) Applicant: Siemens Healthineers AG, Forchheim (DE)

(72) Inventors: Wei FAN, Erlangen (DE); Thomas WEIDINGER, Erlangen (DE); Leopold OTT, Ahorn (DE); Josef DEURINGER, Herzogenaurach (DE)

(73) Assignee: Siemens Healthineers AG, Forchheim (DE)

(21) Appl. No.: 19/332,477

(22) Filed: Sep. 18, 2025

(30) Foreign Application Priority Data
Sep. 19, 2024 (EP) 24201359.7

(51) Int. Cl. H05G 1/30; H05G 1/26

(52) U.S. Cl. CPC H05G 1/30; H05G 1/265

(57) ABSTRACT

An electronic circuit includes an inverter and a controller. The inventor is configured to: obtain a DC heating voltage at an input side; convert the DC heating voltage into an AC heating voltage based on a manipulated variable; and make the AC heating voltage available at an output side. The controller is configured to: measure the DC heating voltage and a DC heating current that results from the DC heating voltage; determine a controlled variable based on the DC heating voltage and the DC heating current; and change the manipulated variable based on the controlled variable to control the controlled variable in an internal control circuit to a setpoint value.

### CROSS-REFERENCE TO RELATED APPLICATION(S)

The present application claims priority under 35 U.S.C. § 119 to European Patent Application No. 24201359.7, filed Sep. 19, 2024, the entire contents of which is incorporated herein by reference.

### FIELD

One or more example embodiments of the present invention relate to an electronic circuit for providing an AC heating voltage for heating a filament of an X-ray tube. In addition, one or more example embodiments of the present invention relate to an X-ray tube system having such an electronic circuit and to a medical imaging system having such an X-ray tube system. One or more example embodiments of the present invention also relate to corresponding methods.

### BACKGROUND

An X-ray tube is a special electron beam tube for generating X-rays. X-ray tubes are used in various imaging methods and offer a plurality of possibilities, including in modern medicine.

To generate X-ray radiation via an X-ray tube, free electrons are required, which can be accelerated from a cathode to an anode with the aid of a defined tube high voltage. The released electrons, i.e. charges, per unit time that flow from the cathode to the anode are referred to as a tube current. In order to generate the free electrons, the cathode is formed as a filament, for example in the form of a tungsten emitter. The filament is heated by an electric current flow to such an extent that electrons detach from the metal grid of the filament. The current flow through the filament is referred to below as a filament current.

An X-ray dose that is generated depends on the tube high voltage and the tube current. The tube current is related to the filament current. The filament current must therefore be adjusted so that the desired temperature of the filament is achieved and thus the appropriate tube current is generated.

Since in many cases the cathode is at a high voltage potential resulting from the tube high voltage, in such cases a galvanic isolation in the form of a transformer, also called a heating transformer, is necessary for reasons of insulation. As a result, the filament current can only be directly detected at high voltage potential with complex and cost-intensive evaluation electronics. If necessary, this evaluation electronics would have to exchange data with the control electronics for the semiconductor switches on the primary side. Instead, in the prior art, the primary-side current of the transformer, which is referred to as the AC heating current, is measured and used as a controlled variable.

Since the emission curve of the X-ray tube, which reflects the ratio between the AC tube current and the AC heating current, can have a very large gradient, a very precise detection of the AC heating current is necessary, which is also associated with high circuitry outlay and cost.

At present, an effective value of the AC heating current is measured as precisely as possible in known applications. For this purpose, an additional measuring transformer is necessary for a primary-side detection of the AC heating current, which also ensures potential isolation to the control electronics. Its secondary-side current is converted via a measuring resistor into a voltage in the form of a high-frequency signal. For an evaluation of this high-frequency signal, a comparatively complex integrated analog circuit is necessary for determining a DC signal corresponding to the effective value. As an alternative to the analog realization of the effective value detection, a corresponding digital filter with comparable functionality can be used. This requires a high oversampling of the high-frequency signal in order to achieve sufficient accuracy in the effective value, which likewise requires a comparatively expensive signal processing chain.

Since certain tolerances in the detection of the AC heating current and temperature dependencies in a heating power channel nevertheless remain and an emission characteristic of an X-ray tube is also subject to a certain tolerance, an actual ratio between the tube current and the AC heating current must be calibrated by test scans in order to meet the requirements for the tube current. This procedure is called filament learning. Due to the aging of the emitter resistor or the filament resistor and the associated change in its resistance value, the filament learning must be repeated at defined intervals in order to continue to enable sufficient accuracy. The approach described is described in detail in the technical literature, for example in [Behling, 2021: Modern Diagnostic X-Ray Sources: Technology, Manufacturing, Reliability].

### SUMMARY

It is an object of one or more example embodiments of the present invention to control the tube current more accurately and/or more rapidly to the predefined setpoint value.

At least this object is achieved by the respective subject matter of the independent claims. Advantageous developments and preferred embodiments are the subject matter of the dependent claims, the following description and also the figures.

One or more example embodiments of the present invention are based on the idea of controlling the heating of the filament on the basis of a controlled variable that depends on the DC heating current and the DC heating voltage at the input side of an inverter.

In accordance with one aspect of one or more example embodiments of the present invention, an electronic circuit for providing an AC heating voltage for heating a filament of an X-ray tube is disclosed. The electronic circuit has an inverter that is configured so as to obtain a DC heating voltage on the input side and to convert the DC heating voltage into an AC heating voltage in dependence upon a manipulated variable and to make the AC heating voltage available on the output side. Moreover, the electronic circuit has a control arrangement that is configured so as to measure the DC heating voltage and a DC heating current that results from the DC heating voltage, in particular on the input side of the inverter, and so as to determine a controlled variable in dependence upon the DC heating voltage and the DC heating current. The control arrangement is configured so as to change the manipulated variable in dependence upon the controlled variable in order to control the controlled variable in an internal control circuit to a predetermined setpoint value.

In other words, the electronic circuit can provide a controllable AC heating voltage, which is generated from the DC heating voltage, at the output of the inverter, which can be used for heating the filament. The AC heating voltage can be galvanically isolated from the filament, for example, and can be conducted via a transformer, for example. This corresponds to an indirect provision of the AC heating voltage to the filament. The AC heating voltage can then be connected to the transformer on the primary side. The transformer can provide a filament voltage on the secondary side that is connected to the filament. The filament voltage depends in particular on the AC heating voltage. The filament voltage can cause a filament current that heats the filament. The transformer can be configured in such a manner that the filament voltage has a higher voltage amplitude than the AC heating voltage; in particular, the filament voltage can also be referred to as a high filament voltage.

In other embodiments, the AC heating voltage can be connected directly to the filament. This can be, for example, an alternative in the event that galvanic isolation is not necessary. In particular, galvanic isolation is not required if a voltage level of the tube high voltage on the filament corresponds to a ground level or is close to a ground level.

The concept of the internal control circuit can be understood in such a way that the internal control circuit is either the only control circuit that is relevant to the corresponding embodiment of the present invention or that the internal control circuit is subordinate to an external control circuit. In the event that the internal control circuit is the only control circuit, the term internal control circuit can be equated with the term control circuit. The designation internal control loop can then also be equated with the designation control loop.

As an alternative to the described arrangement consisting of the internal control circuit and the external control circuit, it is also possible, for example, to operate a first control circuit for the heating power in parallel with a second control circuit for the tube current. This structure is referred to as an override control structure, characterized in that the controller output with the lower value is used as the manipulated signal.

In the case that the electronic circuit has an external control circuit, this can in particular be designed to be slower than the internal control circuit and/or, for example, be configured to control the setpoint value of the internal control circuit.

The inverter can generate a variable output voltage. In the present case, the output voltage is the AC heating voltage. The manipulated variable can also be referred to as the operating parameter of the inverter. The inverter can thus generate the AC heating voltage, which can change in dependence upon the value of the operating parameter. In particular, a modulation level of the inverter can be changed via the manipulated variable. The inverter can in particular have a full bridge or a half bridge in combination with a capacitive voltage divider that halves the DC heating voltage. The full bridge or the half bridge can be controlled, for example, via a PWM signal.

The control arrangement includes, for example, a measuring facility that is configured so as to measure both the DC heating voltage and the DC heating current on the input side of the inverter; that is, it includes, for example, a voltage measuring device and a current measuring device. In this case, the two values can be measured independently of one another. The control arrangement also includes, for example, a controller that is configured so as to calculate the controlled variable and to output the manipulated variable on the basis of the controlled variable. The controlled variable can be composed of the measured values of the DC heating voltage and the DC heating current or can be calculated in dependence upon these values, that is, only in dependence upon the DC heating voltage and the DC heating current or in dependence upon additional variables. The calculation of the controlled variable can in particular include a multiplication of the DC heating voltage by the DC heating current or a division of the DC heating voltage by the DC heating current or vice versa.

The manipulated variable can be made available on the output side of the control arrangement and is connected to the inverter. For the controlled variable, it is possible to predetermine a setpoint value, to which the controller adjusts its control. In particular, the controller can differentiate between the controlled variable and the setpoint value and control it to a target value of the difference of zero. It is also possible for the setpoint value to change within the control process, i.e. for the setpoint value to be adjusted.

A change in the manipulated variable can result in a change in the AC heating voltage, since the modulation level of the inverter can change. As soon as a filament is connected either directly or indirectly to the electronic circuit, a change in the AC heating voltage can result in a change in the AC heating current or the filament current and thus change the temperature of the filament. The temperature of the filament can in turn influence a tube current and thus change an X-ray dose and is thus a decisive factor for the quality of an X-ray exposure.

An advantage of the described invention is the simple measurement of the relevant parameters for the control in the DC voltage or DC current range without complex measuring devices or a need for galvanic isolation. The measurement of these output variables is easier and more cost-effective than a measurement in the AC voltage or AC current range. Likewise, no effective value formations are necessary, since the output variables are directly available. The measurement also allows a simpler structure in terms of cooling the components, in particular it is possible to omit, for example, heat sinks, which are necessary in the case of a measurement in the AC voltage or AC current range.

Furthermore, the gradient of the relationship between an AC heating current and the tube current is relatively high, i.e. a small change in the AC heating current already has a large effect on the tube current. A conventional control, which is based on the AC heating current as a controlled variable, can therefore only control relatively slowly and include a large number of overshoots. The gradient is significantly flatter if a controlled variable is used, which is composed of the components DC heating current and DC heating voltage. This is the case with the electrical circuit in accordance with one or more example embodiments of the present invention, as a result of which, inter alia, the abovementioned object is achieved.

Ultimately, as a result the exposure time and thus the applied X-ray dose of an X-ray exposure can also be reduced.

A further advantage is that the process of filament learning only has to be performed after significantly longer time intervals. This is due to the fact that the dependence of an emission on the DC heating voltage and the DC heating current has a significantly lower gradient. Thus, the tolerance range with respect to the aging of the filament is greater. An essential property of the filament, for example in the form of an impedance of the filament, can be estimated on the basis of the measurement of the DC heating voltage and the DC heating current and a knowledge of the other circuit parts and thus does not have to be taught in a complex manner. In particular, the estimation of the impedance of the filament can also enable predictive maintenance for the X-ray tube.

In accordance with at least one embodiment of the electronic circuit, the control arrangement is configured so as to determine a heating power from the DC heating voltage and the DC heating current. The control arrangement is also configured so as to determine the controlled variable in dependence upon the heating power.

In other words, the control arrangement can calculate the heating power from the measured values of the DC heating voltage and the DC heating current, in particular as a product of these values. The embodiment also includes the case that the controlled variable corresponds to the heating power. Alternatively, the controlled variable can also be directly proportional to the heating power, or there can be another defined relationship between the heating power and the controlled variable.

In comparison to the high gradient of the relationship between an AC heating current and the tube current, the relationship between the heating power and the tube current has a significantly flatter profile. For this reason, control of the heating power is more accurate and can reach the desired variable more rapidly. In particular, possible overshoot of a control process can be reduced or avoided with the presented embodiment.

In accordance with at least one further embodiment of the electronic circuit, the control arrangement is configured so as to control the predetermined setpoint value of the controlled variable in dependence upon the heating power and the manipulated variable in an external control circuit.

In such embodiments, the control of the controlled variable to the setpoint value can be understood as an internal control circuit having corresponding internal control loops, and the control of the setpoint value can be understood as an external control circuit having corresponding external control loops.

The external control circuit can be superimposed on the internal control circuit and control the setpoint value of the internal control circuit based on the heating power and the manipulated variable. The heating power can be determined from the DC heating voltage and the DC heating current. In particular, a plurality of internal control loops can be performed during an external control loop.

A further controlled variable for the external control circuit can be determined in dependence upon the heating power and the manipulated variable. The heating power and the manipulated variable have a direct influence on the temperature of the filament. Therefore, in some embodiments, the further controlled variable can correspond to an effective impedance of the filament or an impedance equivalent of the filament.

An advantage of this embodiment is the acceleration of the control process, in particular in a start phase or in a warm-up phase of an exposure process. The limitation of the maximum manipulated variable can be explicitly set to a higher value, for example, in order to transport a larger amount of energy into the filament and thus shorten the warm-up phase.

This can also be advantageous, in particular, because, after the start of an X-ray exposure, a tracking of the tube current by increasing or, in particular, reducing the AC heating current is possible only against the background of a thermal time constant of an emitter resistance, that is, of the filament, which can be of the order of magnitude of an exposure duration of an X-ray exposure. A tube current does not flow until the tube high voltage is switched on. It is therefore desirable that the tube current is as close as possible to the target value at the beginning of the exposure.

In accordance with at least one further embodiment of the electronic circuit, the control arrangement is configured so as to determine a heating impedance from the DC heating voltage and the DC heating current. The control arrangement is also configured so as to determine the controlled variable in dependence upon the heating impedance.

In particular, the control arrangement can be configured so as to determine the heating impedance from the DC heating voltage, the DC heating current and the modulation level of the inverter or the manipulated variable.

In particular, the heating impedance can also be referred to as the heating impedance equivalent, since the heating impedance of the filament cannot be present directly, but can be determined, for example, from the variables of the DC heating voltage, the DC heating current and the manipulated variable.

In other words, the control arrangement can calculate the heating impedance from the measured values of the DC heating voltage and the DC heating current, in particular as a quotient of these values, the DC heating voltage being the dividend and the DC heating current being the divisor. In particular, the heating impedance can also be referred to as heating resistance. The embodiment also includes the case that the controlled variable corresponds to the heating impedance. In particular, the controlled variable can also be directly proportional to the heating impedance.

Here and below, the term impedance can refer to both a complex-value impedance and a real-value impedance, i.e. an ohmic resistance, unless stated otherwise.

In comparison to the high gradient of the relationship between an AC heating current and the tube current, the relationship between the heating impedance and the tube current has a significantly flatter profile. For this reason, control of the heating impedance is more accurate and can reach the setpoint variable more rapidly. In particular, possible overshoot of a control process can be reduced or avoided with the presented embodiment.

In accordance with at least one further embodiment of the electronic circuit, the control arrangement is configured so as to set the DC heating current to a predefined initial value prior to performing an initial internal control loop of the internal control circuit.

In other words, the control process of the internal control circuit can start with a value for the DC heating current, which is included in the heating impedance as a divisor, from a low positive value as a predefined initial value. In this context, low means small compared to measured values that were determined in previous measurements. A value of the DC heating current of close to zero or equal to zero would cause the heating impedance to rise to very large values or to a value of infinity.

An advantage of this embodiment is an improved convergence of the internal control circuit against the setpoint value, in particular in the start phase of the measurement.

In accordance with at least one further embodiment of the electronic circuit, the AC heating voltage is a non-sinusoidal AC voltage and the manipulated variable corresponds to the pulse/pause ratio of the AC heating voltage.

In particular, the AC heating voltage can include or be composed of a sequence of pulses, in particular rectangular pulses. The AC heating voltage can in particular be composed of a sequence of pulses with a fixed frequency. The manipulated variable can then correspond to the pulse/pause ratio of the pulses. In this case, a high pulse/pause ratio can correspond to a high energy content of the AC heating voltage and thus cause a high filament current, i.e. lead to a high temperature of the filament. In contrast, a low pulse/pause ratio can correspond to a low energy content of the AC heating voltage, i.e. cause a lower value of the filament current and lead to a lower temperature of the filament.

This type of AC heating voltage offers the advantage of easy implementation in modern and cost-effective circuit technology and the rapid and accurate adaptation of necessary parameters. In this case, the inverter can be designed as a PWM inverter. This embodiment is also advantageous in terms of the speed of a switching process and the accuracy of the control of the filament current.

In accordance with at least one further embodiment, the electronic circuit includes a transformer that is configured so as to obtain the AC heating voltage on the primary side. Moreover, in dependence upon a transformation ratio, the transformer is configured on the secondary side so as to make a filament voltage available for heating the filament. The transformer can also be referred to as a heating transformer.

The transformer can receive the AC heating voltage that the inverter makes available on the output side. In particular, the transformer can ensure the galvanic isolation from the filament at a high voltage potential of the tube high voltage. Due to the transformation ratio, the transformer can also output a higher voltage amplitude on the output side, in particular a significantly higher voltage amplitude, than it receives on the input side. Thus, the transformer can make a filament voltage available for heating the filament. In particular, the filament voltage is an AC voltage.

An advantage of using the transformer is the galvanic isolation of the circuits and the possibility of increasing the voltage amplitude.

In accordance with at least one further embodiment of the electronic circuit, the control arrangement includes a PI controller or a PID controller.

The PI controller or the PID controller is configured in particular so as to change the manipulated variable in dependence upon the controlled variable.

The PI controller (proportional-integral controller) includes both a proportional component and an integral component. In the proportional component, the relationship between an input and an output variable is defined by a step function with a defined gain. The integral component shows a linearly increasing profile between the input and output. The PID controller (proportional-integral-derivative controller) additionally includes a differential component. A step response is an impulse function with theoretically infinite magnitude.

An advantage of using PI controllers is the combination of a rapid reactivity of the proportional component and an exact adjustment without permanent control deviation of the integral component. The PID controller also offers the advantage that even rapid control differences can be compensated for by a strong reaction of the controller. The use of PI or PID controllers simplifies the structure of the electronic circuit in accordance with one or more example embodiments of the present invention and increases the control accuracy.

In accordance with a further aspect of one or more example embodiments of the present invention, an X-ray tube system, in particular an X-ray tube system for a medical imaging system using X-ray radiation, is disclosed, having an electronic circuit, in accordance with one or more example embodiments of the present invention, and an X-ray tube.

In this case, the X-ray tube can include a filament that can be supplied with an AC heating voltage by the electronic circuit. In particular, the electronic circuit is connected to the filament in such a way that the filament voltage can be applied to the filament. In addition to the electronic circuit and the X-ray tube, the X-ray tube system can include other components such as a housing and an X-ray anode.

Further embodiments of the X-ray tube system in accordance with the present invention follow directly from the various embodiments of the electronic circuit in accordance with the present invention. In particular, individual features and corresponding explanations and advantages with regard to the various embodiments of the apparatuses in accordance with present invention can be transferred analogously to corresponding embodiments of the X-ray tube system in accordance with the present invention.

In accordance with a further aspect of one or more example embodiments of the present invention, a medical imaging system having an X-ray tube system in accordance with one or more example embodiments of the present invention is disclosed.

The medical imaging system can be, for example, an X-ray system, in particular a digital X-ray system, both a stationary and a mobile system, or a specialized X-ray device, such as a computed tomography system (CT systems), a cone beam CT system, a mammography system, a dental X-ray system, a fluoroscopy system, an angiography system, a C-arm system or a classical X-ray device.

Further embodiments of the medical imaging system in accordance with the present invention follow directly from the various embodiments of the X-ray tube system in accordance with the present invention or the electronic circuit in accordance with the present invention. In particular, individual features and corresponding explanations and advantages with regard to the various embodiments of apparatuses in accordance with the present invention can be transferred analogously to corresponding embodiments of the medical imaging system in accordance with the present invention.

In accordance with a further aspect of one or more example embodiments of the present invention, a method for providing an AC heating voltage for heating a filament of an X-ray tube is disclosed. In this case, a DC heating voltage is first converted into an AC heating voltage in dependence upon a manipulated variable and the AC heating voltage is made available. In addition, the DC heating voltage and a DC heating current that results from the DC heating voltage are measured, in particular on the input side of an inverter, and a controlled variable is determined in dependence thereon. The manipulated variable is changed in dependence upon the controlled variable in order to control the controlled variable to a predetermined setpoint value, in particular in an internal control circuit.

In accordance with at least one embodiment of the method, the filament is heated in dependence upon the AC heating voltage.

In accordance with at least one further embodiment of the method, the predetermined setpoint value of the controlled variable for a predetermined tube high voltage is dependent upon a relationship between a predetermined tube current and the controlled variable.

In this case, the relationship between the predetermined tube current and the controlled variable can be determined by an upstream calibration. After completion, the calibration can have a value table as a result, which can be stored in a data processing unit, for example, for later use.

In accordance with at least one further embodiment of the method, a heating power is determined from the DC heating voltage and the DC heating current. Moreover, the controlled variable is determined in dependence upon the heating impedance.

In accordance with at least one further embodiment of the method, a heating impedance is determined from the DC heating voltage and the DC heating current. Moreover, the controlled variable is determined in dependence upon the heating impedance.

In particular, in a further embodiment of the method, the heating impedance can be determined from the DC heating voltage, the DC heating current and the modulation level of the inverter or the manipulated variable.

Further embodiments of the method in accordance with the present invention follow directly from the various embodiments of the electronic circuit in accordance with the present invention and vice versa. In particular, individual features and corresponding explanations and advantages with regard to the various embodiments of the electronic circuit in accordance with the present invention can be transferred analogously to corresponding embodiments of the method in accordance with the present invention. In particular, the electronic circuit in accordance with one or more example embodiments of the present invention is designed or programmed so as to implement a method in accordance with one or more example embodiments of the present invention. In particular, the electronic circuit in accordance with one or more example embodiments of the present invention implements the method in accordance with one or more example embodiments of the present invention.

Further features and combinations of features of one or more example embodiments of the present invention appear in the figures and their description and also in the claims. In particular, further embodiments of the present invention do not necessarily have to include all the features of one of the claims. Further embodiments of present invention can have features or feature combinations that are not mentioned in the claims.

### BRIEF DESCRIPTION OF THE DRAWINGS

The present invention is explained in more detail below with the aid of specific exemplary embodiments and associated schematic drawings. In the figures, identical or functionally identical elements can be provided with the same reference characters. The description of identical or functionally identical elements may not necessarily be repeated with regard to different figures.

In the drawings:

FIG. 1 shows a schematic block diagram of an exemplary embodiment of an electronic circuit in accordance with the present invention; and

FIG. 2 shows a schematic block diagram of a further exemplary embodiment of an electronic circuit in accordance with the present invention; and

FIG. 3 shows a schematic illustration of a relationship between the relative AC heating current and the relative heating power in relation to the tube current; and

FIG. 4 shows a schematic block diagram of a further exemplary embodiment of an electronic circuit in accordance with the present invention; and

FIG. 5 shows a schematic block diagram of a further exemplary embodiment of an electronic circuit in accordance with the present invention.

### DETAILED DESCRIPTION

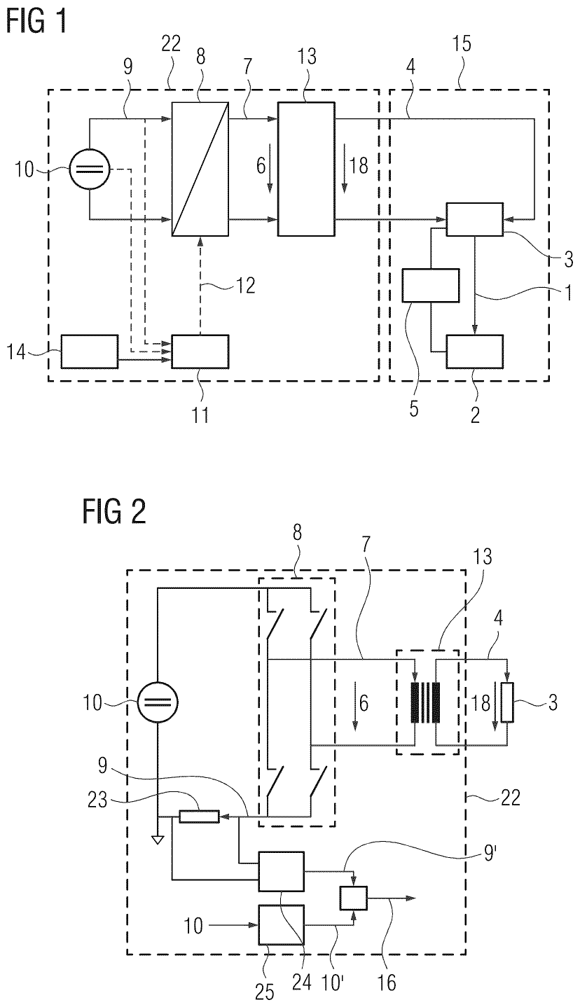

FIG. 1 illustrates an embodiment of an electronic circuit 22 in accordance with the present invention for providing an AC heating voltage 6 for heating a filament 3 of an X-ray tube 15. The electronic circuit 22 has an inverter 8 that is configured so as to obtain a DC heating voltage 10 on the input side and to convert the DC heating voltage 10 into an AC heating voltage 6 in dependence upon a manipulated variable 12 and to make the AC heating voltage 6 available on the output side of the inverter 8. Moreover, the electronic circuit 22 has a control arrangement 11 that is configured so as to measure the DC heating voltage 10 and a DC heating current 9 that results from the DC heating voltage 10 and so as to determine a controlled variable in dependence upon the DC heating voltage 10 and the DC heating current 9. The control arrangement 11 is configured so as to change the manipulated variable 12 in dependence upon the controlled variable in order to control the controlled variable in a control circuit, for example in an internal control circuit, to a predetermined setpoint value 14.

FIG. 1 also schematically illustrates an anode 2 of the X-ray tube 15 and a tube high voltage 5 that is applied between the filament 3 and the anode 2 and a tube current 1. These two variables can be decisive for an X-ray dose, which can occur in an X-ray exposure and acts on an object to be examined.

The control arrangement 11 can include in the internal control circuit a measuring arrangement, having at least one measuring device for measuring the DC heating voltage 10 and the DC heating current 9 and an internal controller 20, and optionally a logic inverter 21. In at least one embodiment, the internal controller 20 can have a PI or a PID controller. In this case, the type of controller can influence the control behavior with regard to an amplitude deviation of the controlled variable and its temporal transient process. In this case, for example, the control arrangement 11 can determine the controlled variable as a product or as a quotient of these two variables from the DC heating voltage 10 and the DC heating current 9. In the case that the DC heating voltage 10 is multiplied by the DC heating current 9, the controlled variable can therefore be referred to as heating power 16. In the case that the DC heating voltage 10 is the dividend and the DC heating current 9 is the divisor, the controlled variable can also be referred to as the heating impedance 17. The predetermined setpoint value 14 can serve as an input variable of the control arrangement 11 and can be used within the control arrangement 11 for matching with the controlled variable. In this case, the logic inverter 21 can, for example, first invert the value of the controlled variable and then the internal controller 20 can compare the inverted value of the controlled variable with the setpoint value 14, in particular by differentiation.

The manipulated variable 12 can be made available to the inverter 8 by the control arrangement 11. In at least one embodiment, the manipulated variable 12 can correspond to a pulse/pause ratio of the AC heating voltage 6. It is possible using the pulse/pause ratio to adjust the average AC heating voltage 6 and, as a result, the average AC heating current 7 through the filament 3. These two variables can be decisive for the temperature of the filament 3.

FIG. 1 also illustrates a transformer 13 that can galvanically isolate the AC heating voltage 6 from a circuit of the filament 3. In some embodiments, the transformer 13 is part of the electronic circuit 22. The transformer 13 receives the AC heating voltage 6 on the input side and can generate a filament voltage 18 therefrom. In dependence upon a transformation ratio, the transformer 13 can transform the AC heating voltage 6, for example, into a high voltage. The filament voltage 18 can be, for example, an AC voltage. The filament voltage 18 can lead to a filament current 4 that flows through the filament 3 and can therefore be decisive directly for a temperature change of the filament 3.

A further exemplary embodiment of the electronic circuit 22, which is based on the embodiment of FIG. 1, is illustrated in the block diagram of FIG. 2. The DC heating current 9 can be measured, for example, via a measuring resistor 23 and can be detected, for example, using an optional low-pass filter 24, which can be used to smooth the DC heating current 9. In addition, the DC heating voltage 10 can be measured and can also be detected via an optional low-pass filter 25, which can be used to smooth the DC heating voltage 10. In this context, smoothing can be understood as averaging the measured value over a predetermined time interval. Such smoothing can, for example, remove short-term current or voltage peaks from a measurement in order to improve a control. The controlled variable can be determined from both smoothed signals, namely the smoothed DC heating current 9 and the smoothed DC heating voltage 10. In this embodiment, the controlled variable is represented as heating power 16, which results from a multiplication of the two signals.

FIG. 2 illustrates the inverter 8 by way of example as a full-bridge inverter. Here, full-bridge topologies with or without a resonant circuit can be used, for example with power semiconductors with reverse voltages below 100 V and preferably in SMD construction. These can be, for example, Si-MOSFETs or GaN-FETs. A phase modulation (phase shift modulation) or a switching frequency modulation can be particularly suitable as the control method. Other types of inverters 8 can also be used.

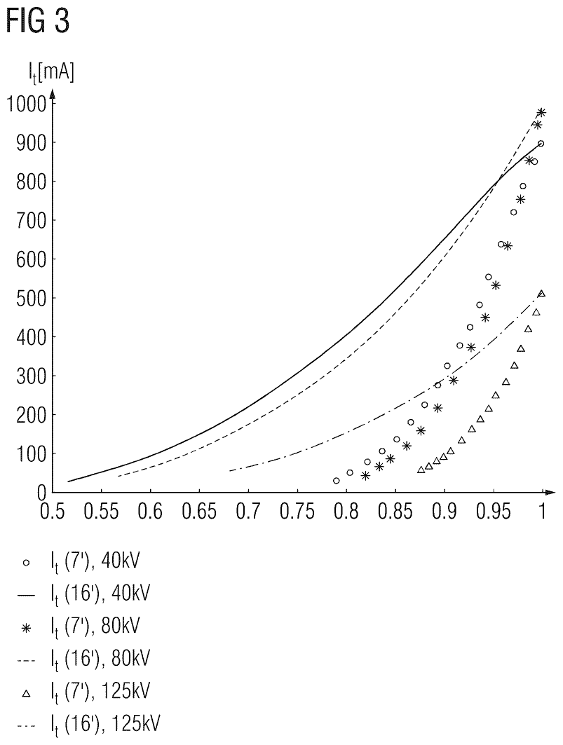

FIG. 3 illustrates a function diagram that illustrates a fundamental relationship between a relative AC heating current 7′ and a relative heating power 16′ with the tube current 1, here referred to as It and plotted in milliamps on the ordinate axis. In this context, relative is defined as the quotient of the value of the AC heating current 7 and the maximum value of the AC heating current 7 or as the quotient of the value of the heating power 16 and the maximum value of the heating power 16. The relationship is shown here for various tube high voltages 5, in particular for the tube high voltages 5 of 40 kV, 80 kV and 125 kV. The relationship can depend on various factors in a medical imaging system, for example, the structure and type of the filament 3, and can also differ from the illustration for certain embodiments. In this case, it is apparent in the illustration that the three curves that are illustrated for the relative AC heating current 7′ have a relatively large gradient, that is to say a high gradient, especially in comparison with the three curves that relate to the relative heating power 16′. A small change in the relative AC heating current 7′ therefore has a large effect on the tube current 1, It. The relationship between the relative heating power 16′ and the tube current 1, It is significantly flatter, so a small change in the relative heating power 16 has a small effect on the tube current 1, It. In particular, the difference in the gradients can be smaller, for example, by a factor of 3.5.

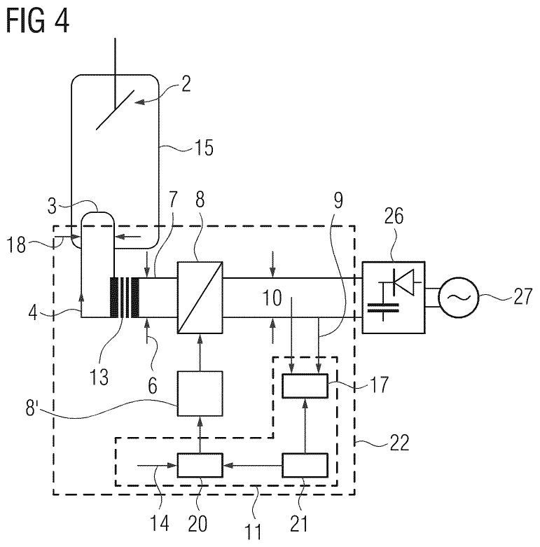

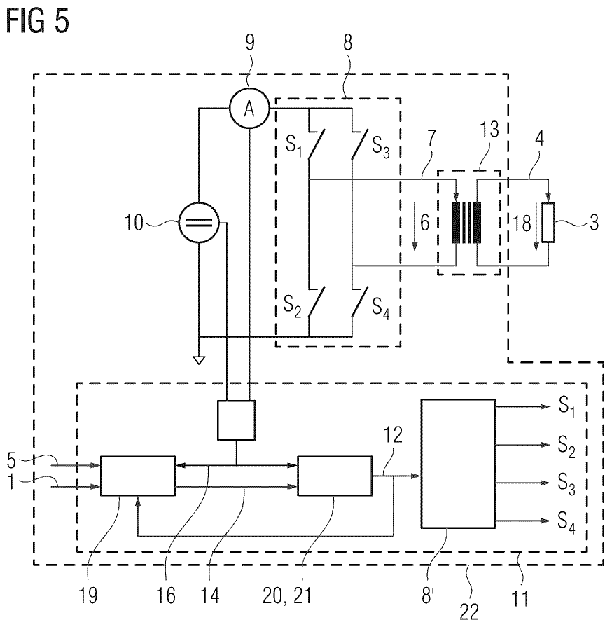

A further exemplary embodiment of the electronic circuit, which is based on the embodiment of FIG. 1, is illustrated in FIG. 4. An exemplary AC voltage supply 27 is illustrated there, which is connected to a supply rectifier 26. The supply rectifier 26 can make the DC heating voltage 10 available to the electronic circuit 22. This DC heating voltage 10 can be made available to the inverter 8 and cause a DC heating current 9. The control arrangement 11 is configured so as to measure the DC heating current 9 and the DC heating voltage 10 and to calculate the controlled variable therefrom; in this embodiment, the controlled variable is, for example, a heating impedance 17. In this case, the heating impedance 17 can be the quotient of the DC heating voltage 10 and the DC heating current 9. In at least this embodiment, the heating impedance 17 can represent the controlled variable for the internal controller 20 of the control arrangement 11. In addition, a logic inverter 21 is illustrated in FIG. 4, which can invert the obtained value of the heating impedance 17 for matching with the setpoint value 14. The inverted value of the heating impedance 17 can be compared with the setpoint value 14 in the internal controller 20. The internal controller 20 can be designed as a PI controller or as a PID controller with the features already described above.

On the basis of the sum of the inverted value of the heating impedance 17 and the setpoint value 14, a value of the manipulated variable 12 is obtained, which the internal controller 20 can make available to a control signal generation 8′. The control signal generation 8′ can, for example, generate individual switch positions as an input signal of the inverter 8 and make them available to the inverter 8. The AC heating voltage 6 can be made available at the output of the inverter 8, in particular to the transformer 13. Depending on the transformation ratio, the transformer 13 can generate a filament voltage 18 from the AC heating voltage 6 and make it available to the filament 3. In this case, the filament voltage 18 can produce the filament current 4.

In addition, FIG. 4 illustrates the X-ray tube 15, which includes the anode 2 in addition to the filament 3.

The control based on the heating impedance 17 has the advantage, in particular, that the desired temperature of the filament 3 can be reached particularly early. From Ohm's law follows

$${R}_{f} = \frac{{U}_{f}}{{I}_{f}} = ρ \frac{l}{s} = {ρ}_{0} ( 1 + a T ) \frac{l}{s} ,$$

wherein R_{f} denotes the ohmic resistance of the filament 3, U_{f} denotes the voltage that is applied to the filament 3 and I_{f} denotes the current flowing through the filament 3, ρ denotes the specific resistance of the filament 3, l denotes the length of the filament 3, s denotes its cross-sectional area, ρ₀ denotes the specific resistance of the filament 3 at 0° C., a denotes the temperature coefficient of the specific resistance, and T denotes the temperature of the filament 3 at 0° C. For tungsten, for example, you have

$$a = 0 , 0046 \frac{1}{°C .}$$

and ρ₀=5,5*10⁻⁸ Ωm.

From this, the following equation can be derived for calculating the temperature:

$$T = \frac{( \frac{{R}_{f} \frac{s}{l}}{{ρ}_{0}} - 1 )}{a} = \frac{{R}_{f} s}{a {ρ}_{0} l} - \frac{1}{a} = k {R}_{f} - b = k \frac{{U}_{f}}{{I}_{f}} - b ,$$

$$wherein k = \frac{s}{a {ρ}_{0} l} and b = 1 / a .$$

It follows that the temperature of the filament 3 depends linearly on its resistance. This linearity leads to the fact that the control with the internal control circuit leads to the fact that the temperature can be brought to the setpoint value in a more stable, precise and rapid manner.

The measurement of the two values U_{f} and I_{f} can be regarded as equivalent to measuring the temperature of the filament 3. Since the direct measurement of these two values technically is difficult and expensive, it is advantageous to use other variables that are easier to measure and are directly related to R_{f}, as is realized in the present case for FIG. 4 by the described measurement of the DC heating voltage 10 and the DC heating current 9.

The following algorithm can be used, for example:
1. Setting a new expected filament resistance R_{ref}, which was learned by filament learning.
2. Setting a small current I_{d} through the filament 3 so that the feedback current is not exactly zero.
3. Measuring the DC heating voltage 10 and the DC heating current 9.
4. Calculating the actual filament resistance R_{d}.
5. Calculating the difference ΔR between an expected filament resistance R_{ref} and the actual filament resistance R_{d}.
6. Using the internal controller 20 to calculate the manipulated variable 12 and from that the control signals for the inverter 8 from ΔR.
7. Repeat steps 3 to 7.

Resistance-based filament learning can be implemented, for example, in accordance with the following algorithm:

| | |
|---|---|
| 1. | Setting I_{f} to I_{f,llx} and KV_{s,ls} to 0 (false). |
| 2. | Setting C = 0 and KV = KVₛ[0]. |
| 3. | If KV_{s,ls}[C] = 1 (true), go to step 12. |
| 4. | Applying I_{f} to the filament 3 and waiting for it to stabilize. |
| 5. | Applying the prevailing tube high voltage 5 and exposure time to |

the X-ray tube.

| | |
|---|---|
| 6. | Performing an X-ray exposure and measuring the tube current 1, |

I_{T} and the filament voltage as Uf soon as they are stable.

| | |
|---|---|
| 7. | $Calculating th e resistance R = \frac{{U}_{f}}{{I}_{f}} .$ |
| 8. | Saving the tuple (KV, I_{f}, I_{T}, U_{f}, R) . |
| 9. | If I_{f} > I_{f,ulx}, setting KV_{s,ls} to 1 (true) . |
| 10. | If I_{T} > min(I_{T,ulg}, I_{T,ulx}), setting KV_{s,ls} to 1 (true) . |
| 11. | $If {I}_{T} > min ( \frac{{P}_{ulx}}{K V} , \frac{{P}_{ulg}}{K V} ) , setting {KV}_{s , ls} to 1 ( true ) .$ |
| 12. | Setting C → C + 1. |
| 13. | If C < C_{KV}, setting KVₛ(C_{KV}) and go to step 3. |
| 14. | If all elements of KV_{s,ls} are set to 1 (true), go to step 16. |
| 15. | If I_{f} → I_{f} + I_{f,s}, setting C = 0, KV = KVₛ[0] and go to step 3. |
| 16. | End. |

In this case, C_{KV} denotes the number of the X-ray voltages that are taken into account, I_{f,ulx} denotes an upper limit for the current through the filament 3, I_{f,llx} denotes a lower limit for the current through the filament 3, I_{T,ulx} denotes an upper limit for the tube current 1, I_{T,ulg} denotes a maximum available tube current 1, Pᵤₗₓ denotes an upper limit for the tube power, P_{ulg} denotes a maximum available tube power, I_{f,s} denotes a predetermined current value step, KVₛ denotes an array of the magnitude C_{KV}, which stores all the X-ray voltages that are taken into account, and KV_{s,ls} denotes an array of the magnitude C_{KV}, which stores information as to whether the learning is completed for the individual X-ray voltages.

An advantage is that the internal controller 20 does not have to know the filament voltage 18 and the filament current 4. In addition, the filament current 4 can be kept more stable, since it is controlled by its resistance in terms of temperature. This is very helpful, for example, for time-critical X-ray exposures under the requirement of a high time-space resolution.

In addition, with this control, the filament 3 does not become too hot or too cold at the beginning of the X-ray exposure, which would lead to too high or too low a dose rate. In the case of a time-controlled exposure, an image that is too bright or too dark can be avoided. In addition, the generator and the X-ray tube 15 can be protected against overload.

The resistance as an indicator for the filament temperature is also advantageous for predictive maintenance, since deviations in the filament temperatures compared to data from the scan history make it easy to detect the filament aging.

FIG. 5 illustrates a further schematic illustration of a further exemplary embodiment of the electronic circuit 22, which is based on that of FIG. 1. In this case, the features already illustrated in the other figures apply, unless otherwise illustrated. In the embodiment illustrated by way of example, in addition to the internal controller 20, the logic inverter 21 and the control signal generation 8′, the control arrangement 11 also includes an external controller 19, which can be superimposed on the internal controller 20. The external controller 19 receives the current values of the tube high voltage 5, the tube current 1 and the values of the controlled variable, in this case the heating power 16, and the value of the manipulated variable 12, in this case the pulse/pause ratio as the modulation level of the inverter 8. From these values, the external controller 19 can calculate an effective impedance of the filament 3, which can also be referred to as the impedance equivalent. The external controller 19 can make the setpoint value 14 available to the internal controller 20, which in this case can also be referred to as an external manipulated variable.

The remaining parts of the electronic circuit 22 can be identical to the parts already illustrated in FIG. 1 and FIG. 2. In particular, FIG. 5 also shows the control signal generation 8′, which can generate the individual switch positions as an input signal of the inverter 8. The designations S1, S2, S3 and S4 characterize in particular an exemplary embodiment in which the inverter 8 has a full bridge and includes four switches. The four switches can be controlled, for example, by the output signals of the control signal generation 8′.

In one exemplary embodiment, in which the inverter 8 includes a full bridge and the DC heating voltage 10 is in the range of a minimum of 24 V and a maximum of 80 V, a very low-loss and compact structure can be realized due to the available very small components, the smaller voltage distances, and the topology as a full bridge; for example, it is possible to omit heat sinks, which are necessary in the case of regulation via variables in the AC voltage or AC current range.

In the described embodiments, the process of filament learning can be performed at longer time intervals. This is due, in particular, to the fact that the aging of the filament 3 and thus its change in the heating impedance 17 is actively mitigated by the use of the heating power 16 as a controlled variable, so that, viewed in an idealized manner, the number of free electrons remains the same. However, since the aging of the filament 3 does not take place uniformly, its emission characteristic nevertheless changes with progressive aging. However, this is done at significantly longer intervals than with the conventional method.

Independent of the grammatical term usage, individuals with male, female or other gender identities are included within the term.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

What is claimed is:

1. An electronic circuit for providing an AC heating voltage for heating a filament of an X-ray tube, the electronic circuit comprising:
an inverter configured to
obtain a DC heating voltage at an input side,
convert the DC heating voltage into an AC heating voltage based on a manipulated variable, and
make the AC heating voltage available at an output side; and
a controller configured to
measure the DC heating voltage and a DC heating current that results from the DC heating voltage,
determine a controlled variable based on the DC heating voltage and the DC heating current, and
change the manipulated variable based on the controlled variable to control the controlled variable in an internal control circuit to a setpoint value.

2. The electronic circuit as claimed in claim 1, wherein the controller is configured to
determine a heating power from the DC heating voltage and the DC heating current, and
determine the controlled variable based on the heating power.

3. The electronic circuit as claimed in claim 2, wherein the controller is configured to control the setpoint value of the controlled variable based on the heating power and the manipulated variable in an external control circuit.

4. The electronic circuit as claimed in claim 1, wherein the controller is configured to
determine a heating impedance from the DC heating voltage and the DC heating current, and
determine the controlled variable based on the heating impedance.

5. The electronic circuit as claimed in claim 4, wherein the controller is configured to set the DC heating current to an initial value prior to performing an initial internal control loop of the internal control circuit.

6. The electronic circuit as claimed in claim 1, wherein the AC heating voltage is a non-sinusoidal AC voltage and the manipulated variable corresponds to a pulse/pause ratio of the AC heating voltage.

7. The electronic circuit as claimed in claim 1, further comprising:
a transformer configured to
obtain the AC heating voltage at a primary side, and
on a secondary side, make a filament voltage available for heating the filament based on a transformation ratio.

8. The electronic circuit as claimed in claim 1, wherein the controller includes a PI controller or a PID controller.

9. An X-ray tube system, comprising:
the electronic circuit as claimed in claim 1; and
an X-ray tube.

10. A medical imaging system comprising:
an X-ray tube system as claimed in claim 9.

11. A method for providing an AC heating voltage for heating a filament of an X-ray tube, the method comprising:
converting a DC heating voltage into an AC heating voltage based on a manipulated variable;
making the AC heating voltage available;
measuring the DC heating voltage and a DC heating current that results from the DC heating voltage;
determining a controlled variable based on the DC heating voltage and the DC heating current, and
changing the manipulated variable based on the controlled variable to control the controlled variable to a setpoint value.

12. A method for heating a filament of an X-ray tube, the method comprising:
implementing the method for providing an AC heating voltage as claimed in claim 11, and
heating the filament based on the AC heating voltage.

13. The method as claimed in claim 11, further comprising:
determining the setpoint value based on a relationship between a tube current and the controlled variable.

14. The method as claimed in claim 11, further comprising:
determining a heating power from the DC heating voltage and the DC heating current; and
determining the controlled variable based on the heating power.

15. The method as claimed in claim 11, further comprising:
determining a heating impedance from the DC heating voltage and the DC heating current; and
determining the controlled variable based on the heating impedance.

16. The electronic circuit as claimed in claim 3, wherein the AC heating voltage is a non-sinusoidal AC voltage and the manipulated variable corresponds to a pulse/pause ratio of the AC heating voltage.

17. The electronic circuit as claimed in claim 3, further comprising:
a transformer configured to
obtain the AC heating voltage at a primary side, and
on a secondary side, make a filament voltage available for heating the filament based on a transformation ratio.

18. The electronic circuit as claimed in claim 5, wherein the AC heating voltage is a non-sinusoidal AC voltage and the manipulated variable corresponds to a pulse/pause ratio of the AC heating voltage.

19. The electronic circuit as claimed in claim 5, further comprising:
a transformer configured to
obtain the AC heating voltage at a primary side, and
on a secondary side, make a filament voltage available for heating the filament based on a transformation ratio.

20. The method as claimed in claim 13, further comprising:
determining a heating power from the DC heating voltage and the DC heating current; and
determining the controlled variable based on the heating power.
